(19) United States
(12) Patent Application Publication
(10) Pub. No.: US 2006/0232025 A1
(43) Pub. Date: Oct. 19, 2006

(54) Control device for a truck having an oscillating axle

(76) Inventor: Marcel-Claude Braud, Ancenis (FR)

Correspondence Address: YOUNG & THOMPSON, 745 SOUTH 23RD STREET, 2ND FLOOR, ARLINGTON, VA, 22202, US

(21) Appl. No.: 11/365,627

(22) Filed: Mar. 2, 2006

(30) Foreign Application Priority Data
Mar. 2, 2005 (FR) 05.02106

(51) Int. Cl. B60G 17/016; B60G 9/02

(52) U.S. Cl. 280/5.508; 280/6.16; 280/124.112

(57) ABSTRACT

A control device, for a truck having an oscillating axle, includes means to determine at least one physical parameter (G) of the truck, and at least one dynamic parameter (F) of the truck, and a device (101) actively to improve the lateral stability of the truck.

The present invention relates to a control device for a truck having an oscillating axle.

U.S. Pat. Nos. 5,639,119 and 5,813,697 describe stabilizing apparatus for the chasses of trucks with telescoping arms. These stabilizing apparatus comprise single acting jacks that bear on the two ends of the rear oscillating axle of the truck, but do not permit reacting against a starting of loss of stability of the truck with the telescoping arm. These stabilizing apparatus thus define three operative modes of the rear axle: a first mode in which the rear axle oscillates freely, a second mode in which the oscillating movements of the rear axle are braked by a hydraulic constriction and a third mode in which the rear is blocked and cannot oscillate.

A first object of the invention is to improve the known state of the art, by providing a new control device permitting reacting against loss of lateral stability.

A second object of the invention is to overcome the drawbacks of the known art, by providing a new control device taking account of the instantaneous dynamic condition of the truck with a telescoping arm for which the device is adapted.

The invention has for its object a control device for a truck having an oscillating axle, comprising means to determine at least one physical parameter of the truck and at least one dynamic parameter of the truck, and means to improve actively the lateral stability of the truck.

According to other alternative characteristics of the invention:
the means to improve actively the lateral stability of the truck comprise means to apply a stabilizing couple to the oscillating axle by actively opposing the unbalancing couple of the truck.
the device comprises at least one detector selected from among detectors of physical values of the truck, namely: the angle of inclination of the boom, the load, the degree of telescoping, the angles of inclination of the truck.
the device comprises at least one detector selected from among detectors of the dynamic values of the truck, namely: angles of the wheel, speed of turning of the wheels, speed of advancing the truck, lateral acceleration of the truck.
the device comprises at least one double acting jack acting on the oscillating axle of the truck to improve actively the lateral stability of the truck.
the device comprises means for processing, computing and control acting on the actuators or members of the truck, particularly on a double acting jack, so as to improve actively the lateral stability of the truck.
at least one jack acting on the oscillating axle is controlled by a module comprising a block for regulating pressure and a block of several distributors having for a function blocking the jack, the free oscillation of the jack and the pressurization of a first chamber of the jack and the pressurization of a second chamber of the jack.
at least one jack acting on the oscillating axle is controlled by a module comprising a block for regulating first pressure in a first pressure chamber of the jack and a block for regulating second pressure of a second chamber of the jack.
the device can preferably comprise two jacks acting on the oscillating axle, to promote the addition of supplemental functions to the oscillating axle.

The invention also has for its object a truck with an oscillating axle provided with a device according to the invention.

The invention will be better understood from the description which follows, given by way of non-limiting example and with reference to the accompanying drawings, in which:

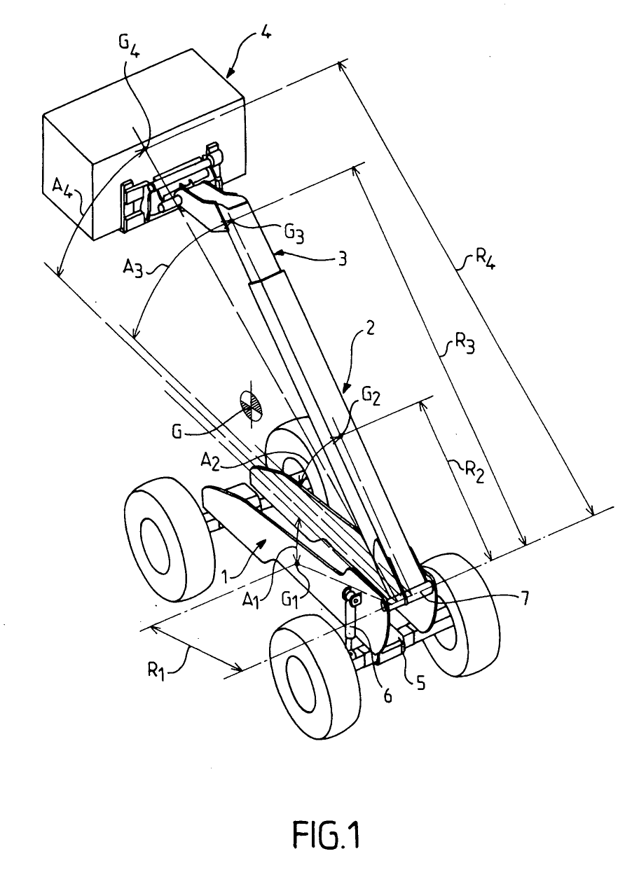

FIG. 1 shows schematically a perspective view of a truck with an oscillating axle according to the invention.

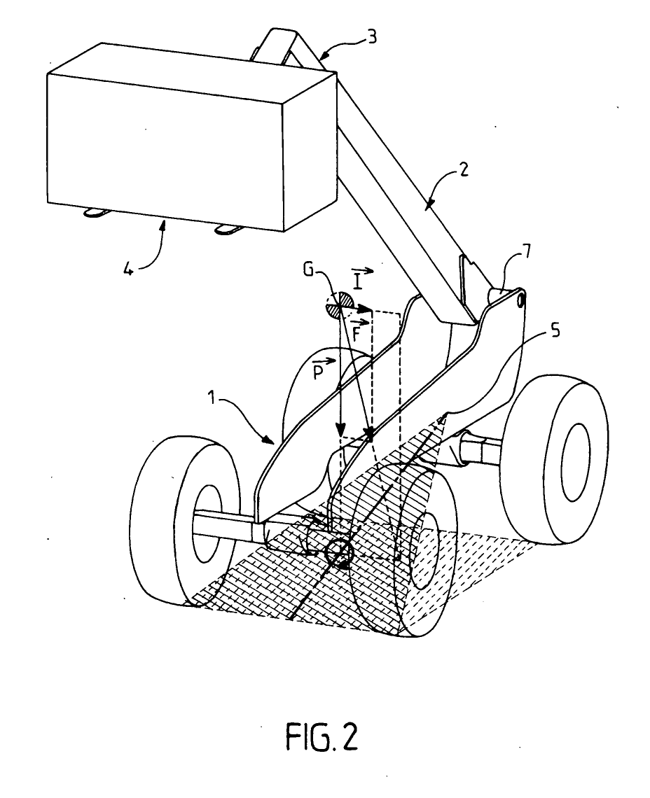

FIG. 2 shows schematically a perspective view showing the variation of lateral stability of a truck with an oscillating axle of the prior art.

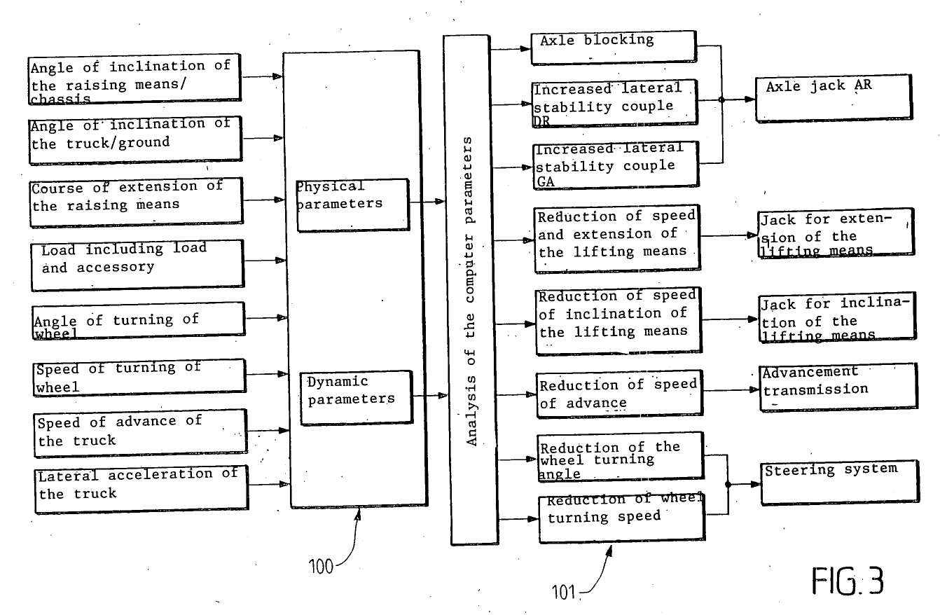

FIG. 3 shows schematically an operating diagram of the device according to the invention.

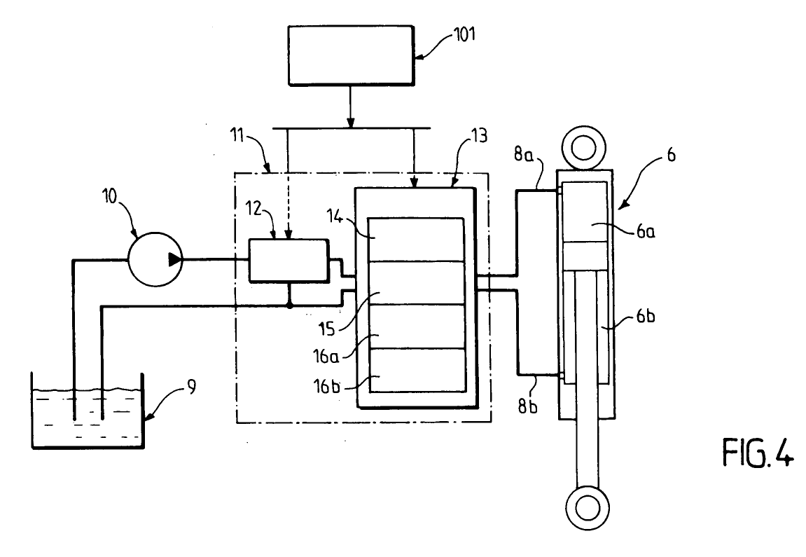

FIG. 4 shows schematically a fragmentary view of a first embodiment of a device according to the invention.

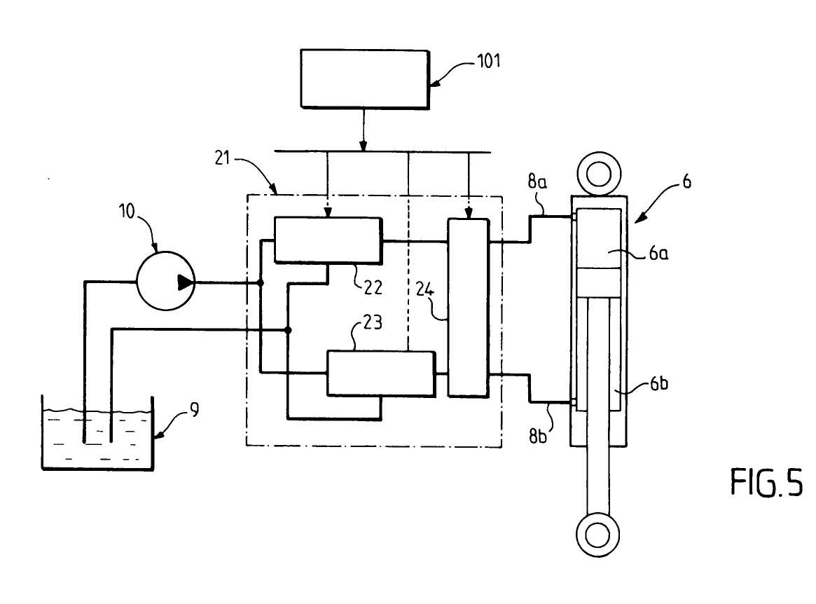

FIG. 5 shows schematically a fragmentary view of a second embodiment of the device according to the invention.

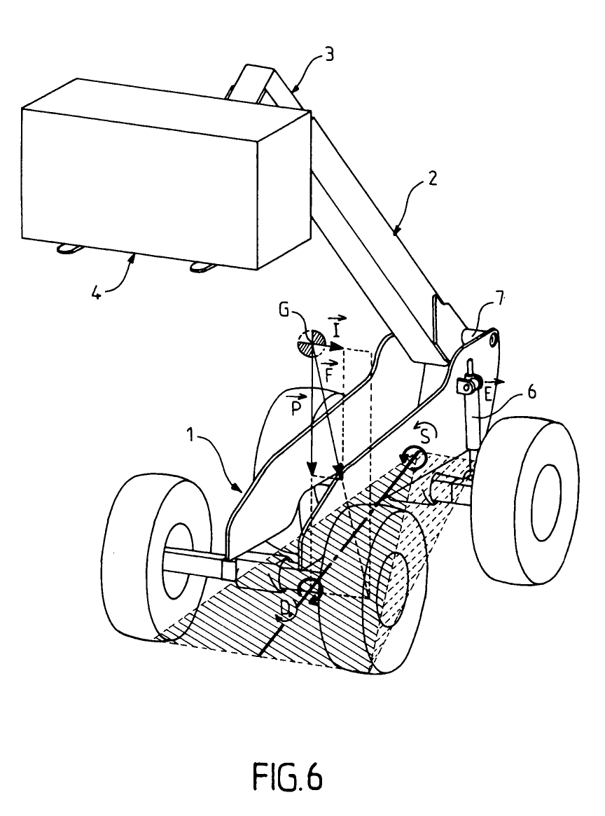

FIG. 6 shows schematically a perspective view illustrating the reaction against a reduction of lateral stability of a truck with an oscillating axle according to the invention.

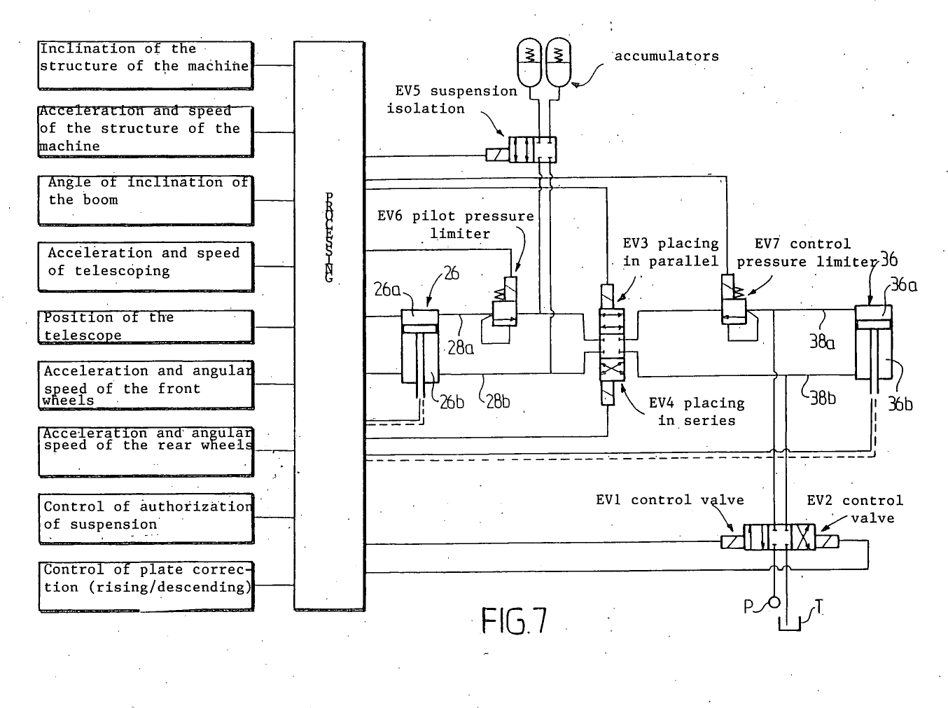

FIG. 7 shows schematically a fragmentary view of a third embodiment of the device according to the invention.

With reference to FIGS. 1 to 6, identical or functionally equivalent elements are given the same reference numerals.

In FIG. 1, a truck with an oscillating axle according to the invention comprises a self-propelled chassis 1 comprising a front non-oscillating axle and a rear oscillating axle, a fixed section 2 of a telescoping arm, a sliding section 3 of a telescoping arm and a load 4 comprising an accessory secured to the sliding section 3 of the telescoping arm and a load carried by said accessory.

The rear axle of the chassis oscillates about an axle 5 under the control of at least one double acting jack 6.

The assembly of self propelled chassis 1 bearing all its equipment and including its front and rear axles has a center of gravity G₁ located at a distance R1 at an angle A1 of inclination relative to the horizontal plane passing through the axle 7 of the articulation pivot of the telescoping arm on the chassis 1.

Detector means of a type known per se are preferably provided to determine continuously the following parameters:
distance R₂ and angle A₂ of inclination to the horizontal of the center of gravity G₂ of the fixed section 2 of the telescopic arm;
distance R₃ and angle A₃ of inclination to the horizontal of the center of gravity G₃ of the sliding section 3 of the telescopic arm;
distance R₄ and angle A₄ of inclination to the horizontal of the center of gravity G₄ of the load 4 including the accessory of the telescopic arm.

From the values or parameters mentioned above continuously measured, there is continuously calculated an indication of the instantaneous position of the center of gravity G of the truck with telescopic arm.

Other means of known type are provided to determine continuously the following parameters:
the angles of inclination of the chassis 1 relative to the horizontal;
the turning radius of the truck with telescopic arm;
the speed of advance of the truck with telescopic arm.

In FIG. 2, a truck with telescopic arm of a type known per se is shown with its center of gravity G, to which is applied the force F resulting from the component P of the perpendicular weight of the chassis 1 and the lateral force I.

When the truck is in movement on horizontal ground, the lateral force I is a lateral force of inertia engendered by the speed of movement and the angle of the wheels of the truck with telescopic arm.

When the truck is in an inclined position, the lateral force I is determined from the transverse component of the weight parallel to the direction of transverse inclination of the chassis 1, and is the lateral force of inertia I if the truck is moving.

When the rear axle can oscillate freely, the lateral stability of the truck depends on the value of the couple of lateral stability of the force F relative to the corresponding side of the triangle of sustension defined by the contact with the ground of the front wheels and the oscillation axle 5 of the rear axle on the chassis 1.

When the rear axle is blocked and cannot oscillate, the lateral stability of the truck depends on the value of the couple of lateral stability of the force F relative to the corresponding side of the quadrilateral of sustension defined by the contact with the ground of the front wheels and the rear wheels.

The invention particularly permits actively improving the lateral stability of the truck by applying a reactive couple between the chassis 1 and the rear oscillating axle thanks to the actuation of a double acting jack 6, whilst keeping the necessary oscillation to maintain the rear wheels on the ground during movement of the truck with a telescoping arm.

The invention thus permits overcoming the drawbacks of the blockage of the oscillating axle of a truck over any terrain, which risks support on only three wheels on an even ground and risks tipping.

In FIG. 3, a device according to the invention comprises at least one detector selected from an assembly of detectors of the following physical values determining an indication of the instantaneous position of the center of gravity G of the truck:
angle of inclination of the boom relative to the chassis;
angles of inclination of the truck with telescoping arm relative to the ground
the degree of telescoping;
load at the end of the telescoping arm including the load and the accessory;

The device according to the invention also comprises at least one detector selected from an assembly of detectors of the following dynamic values:
wheel turning angles;
speed of wheel turning;
speed of forward movement of the truck;
lateral acceleration of the truck.

From values transmitted by the detectors, a physical parameter relating to the center of gravity G and a dynamic parameter relating to the forces applied to the center of gravity G are provided by an interface 100 for processing and computation.

A control module 101 comprises an analysis program and at least one sub-program selected from the assembly of the following sub-programs adapted to improve the lateral stability of a truck with telescoping arm by acting on the following properties:
blockage of the rear axle;
improvement of the right side stability couple;
improvement of the left side stability couple;
reduction of the speed of telescoping;
reduction of the speed of lifting;
reduction of the speed of advance of the truck;
limitation of the angle and/or speed of turning;

The control module 101 acts on the actuators of the following members of the truck:
at least one double acting jack 6 for controlling the rear oscillating axle;
a telescoping jack;
a lifting jack;
a forward motion transmission;
a system of direction;

independently or simultaneously, by suitable control means, of a type known per se as it relates to the telescoping jack, the lifting jack and the forward movement transmission and the steering system.

In FIG. 4, a first device according to the invention comprises at least one control jack 6 for the rear axle with a first chamber 6a and a second chamber 6b supplied respectively by a line 8a and a line 8b.

A control module 11 is connected to a pump or source 10 of pressure and to a reservoir 9 of hydraulic fluid, so as to supply the lines 8a and 8b connected to the chambers 6a and 6b of the jack 6.

The control module 11 is connected to the computer 101 to select a pressure value to be regulated by a pressure regulation block 12 and to select the operation of a distributor forming a portion of the block 13.

The distribution block 13 comprises a distributor of blockage of the jack 6, a distributor 15 of free oscillation of the jack, a distributor 16a of pressurizing the first chamber 6a and a distribution 16b for pressurizing the second chamber 6b.

In FIG. 5, a second device according to the invention comprises at least one jack 6 for controlling the rear axle with a first chamber 6a and a second chamber 6b supplied respectively by a line 8a and a line 8b.

A control module 21 is connected to a pump or pressure source 10 and to a reservoir 9 of hydraulic fluid, so as to supply the lines 8a and 8b connected with the chamber 6a and 6b of the jack 6.

The control module 21 is connected to the computer 101 to select a first pressure value to be regulated by a block 22 for regulating the first pressure and a second pressure value to be regulated by a block 23 for regulation of the second pressure, and to operate or not a blocking member 24, as a function of the condition of stability of the truck with a telescoping arm.

The first hydraulic fluid pressure regulated by the block 22 is adapted to pressurize the first chamber 6a, and a second hydraulic fluid pressure regulated by the block 23 is adapted to pressurize the second chamber 6b.

In FIG. 6, a truck with an oscillating axle according to the invention comprises a front axle rigidly fixed to the chassis 1 and a rear oscillating axle controlled by at least one double acting jack 6.

As a function of the variability of instantaneous lateral stability of the truck, a force E is exerted by the jack 6 to exert a resisting couple between the rear axle and the chassis 1, so as to exert a stabilizing couple S at the level of the oscillation axle 5 of the rear axle.

The force of the stabilizing couple S is such as to actively oppose the disequilibrium couple D created by the resultant force F applied to the instantaneous center of gravity G of the truck with a telescoping arm.

The disequilibrium couple D can be defined as the difference between the values of right lateral stability and left lateral stability, while alternatively as the moment of force F relative to the median of the sustentation triangle passing through the oscillation axle and through the middle of the wheel base of the front axle defined by the middle of the contacts of the front wheels with the ground.

The effect of the stabilizing couple S is to compensate the effect of the lateral force I and thus to make the force F of the plane defined by the center of gravity G of the truck and the median of the sustentation triangle, to approach each other, so as to rebalance the right lateral stability and the left lateral stability.

The invention described with reference to a particular embodiment is no way limited, but on the contrary covers all modification of shape and any variation of embodiment within the scope and spirit of the invention.

In FIG. 7, a third device according to the invention comprises two double acting jacks 26 and 36 for controlling the rear axle.

The double acting jack 26 comprises a first chamber 26a and a second chamber 26b supplied respectively by a line 28a and a line 28b.

The double acting jack 36 comprises a first chamber 36a and a second chamber 36b supplied respectively by a line 38a and a line 38b.

The third device according to the invention ensures the direction of the behavior of the two hydraulic jacks 26 and 36, ensuring functions of suspension and oscillation at the level of the rear axle of a vehicle.

Supplemental hydraulic functions for road travel such as an oleopneumatic suspension, adjustment of the height or raising of the rear axle, can be added by means of a software tool permitting easy adjustment of the different parameters or laws of internal control, via different hydraulic actuators, and as a function of the conditions of the inlets of the system and/or of the appropriate control laws.

The third device according to the invention comprises digital inputs, and analog inputs.

The analog inputs comprise the following entries:
Inclinations of the structure of the machine (inclination of the structure of the machine in the X direction, inclination of the structure of the machine in the Y direction/inclinometer two axes)
Dynamic of the structure of the machine (acceleration and speed of the structure of the machine in the X direction, acceleration and speed of structure of the machine in the Y direction, acceleration and speed of the structure of the machine in the Z direction/three axes accelerometer)
Dynamic of the load (angle of inclination of the beam/angular detector, acceleration and speed of telescoping/accelerometry of one axle; position of the telescope/detector of position (reentry position sufficient?); machine steering wheels (acceleration and angular speed of the front wheels/accelerometer; acceleration and angular speed of the rear wheels/accelerometer)
Instrumentation of the jacks (lowest pressure of jack 26/pressure detector; pressure of piston rod 26/pressure detector; pressure at the bottom of jack 36/pressure detector; pressure of rod and jack 36/pressure detector; course L26 of the jack 26/position detector; course L36 of the jack 36/position detector)

The digital entries comprise the following entries:
Control by the user (control of authorization of suspension/switch; control of correction of plate (rising), control of correction of plate (descending)/rocker three conditions without holding)

The third device according to the invention comprises all or nothing outputs, and proportional outputs.

The all or nothing outputs comprise the following outputs:
Hydraulic jack interface (placing in parallel EV3 of the double acting jacks 26 and 36; placing in series EV4 the double acting jacks 26 and 36/electrovalve with two control heads)
Isolation of suspension (isolation EV5 from the suspension/electrovalve accumulators)

The proportional outputs comprise the following outputs:
Control of regulation (valve EV1 for proportional control; valve EV2 for proportional control; electrovalve with two control heads)
Pressure limiters (adjustment of the standard of the pressure limiter of the base of jack 26/limiter EV6 of pilot pressure; adjustment of the standard of pressure limiter of the base of jack 36/limiter EV7 of pilot pressure)

The third device according to the invention comprises application software to manage the acquisition in real time of the different inputs and signals from detectors, and to control the hydraulic actuators.

The assembly of the low layers of the application software is implemented hard, but the application portion can be modified via an interface thanks to the use of a software tool of code synthesis from a functional description.

An initiation phase (F00: “initialization”) will permit filling the chambers of the jacks if the hydraulic pressures are too low, particularly when the rear of the machine is in a too low position to work.

Another initialization phase (F00: “initialization”) with modification of the control laws will permit filling the chambers of the jacks if the hydraulic pressures are too high, particularly when the rear of the machine is in a position too high to work.

If the machine is not at the limit of frontal stability, the system returns the machine to the medial position. If the machine is on a lateral slope, the lateral stability function (see further on: F3 mode “lateral stability”) compensates the hydraulic pressures which become different. It is necessary to translate the paths of the jack by a same difference to preserve the same pressure difference.

The five principal functions assured after initialization by the third device according to the invention are the following:
F0 mode “oscillation” The axle is rendered oscillating but not suspended
F1 mode “suspension” The hub is still oscillating but suspended
F2 mode “frontal stability” Ensures the permanent control of the longitudinal stability of the machine
F3 mode “lateral stability” Ensures the permanent control of the lateral stability of the machine
F4 mode “plate correction” Permits the correction of the plate in longitudinal axis of the machine

F0 and F1 are functional modes of the system, whilst F2 and F3 are controlled modes ensured permanently which do not interfere with the functional modes F0 and F1 unless action on the actuators becomes necessary.
The F1 mode is the “normal” functioning mode, privileged to the user, which can be the mode of input of the system after the initialization phase. The hydraulic circuit is in a closed loop (EV1=0, EV2=0), the jacks are in parallel (EV3=1), and the accumulators are in service (EV5=1). The oscillation of the axle is free, and the vertical movement with shock absorber spring action against accumulators is possible.

Once in mode F1, the system automatically swings into mode F0 if the angle of the boom becomes greater than a critical threshold or if the output of the telescope becomes greater than a critical threshold.

A control button of the switch type permits the function d′ “authorization of suspension” by the user, following which the suspension can be activated or not by the system: the visualization of the condition effectively activated of the suspension informs the user of this condition.

The actuator EV4 can be used to provide a suspension function (EV5=1) with rigidity on the rear axle (torsion bar). This latter configuration gives a comfort advantage during driving at high speed on a road.

The mode F1 and the suspension function can conversely be deactivated by the user.
F0 is identical to the mode F1, but without suspension: the accumulators are isolated from the circuit (EV5=0).

After the initialization phase the system can pass prioritarily into mode F1 if the height of the axis of the axle is between two high and low limits, if the jack pressures are between two high and low limits, if the boom angle is below a critical threshold, and if the output of the telescope is less than a critical threshold.

Otherwise, the system remains in mode F0.

The mode F4 “plate correction” and the function of correction of the plate are actuated manually by the user, and permit either the descent or the raising of the rear portion of the machine.

The descent command of the machine relative to the axle can take place until a minimum value which is a function of the courses L26 and L36. In this case, EV2 is controlled with a predetermined flow rate (EV2=%), the jacks 26 and 36 are placed in parallel (EV3=1) and the suspension is locked (EV5=0).

The control of raising of the machine relative to the axle can take place until a maximum value which is a function of the courses L26 and L36. In this case, EV1 is controlled with a predetermined flow rate (EV1=%), the jacks are placed in parallel (EV3=1) and the suspension is locked (EV5=0).

The mode F2 “frontal stability” and the control function of the frontal stability use several parameters of the machine to compute the output data in the form of percentage of frontal instability.

The percentage of frontal instability increases when the values corresponding to the sum of the pressures at the base of the two jacks 26 and 36 and to the sum of the pressures of the rods of the two jacks 26 and 36 exceeds predetermined ranges to guarantee a level of stability, which is corrected as a function of the inclination of the structure of the machine provided with the device according to the invention.

The mode F3 “lateral stability” and the control function of the lateral stability are usable, even when the function F2 is deactivated during manipulations, so as to determine their conduct of the function F2.

However, the two functions are normally correlated to ensure an overall control of the stability of the machine.

The object of the control of the lateral stability is not to correct or counterbalance a swinging movement already begun, but to prevent the swinging by providing a pressure opposing the tendency to swing.

The control function of the lateral stability does not modify the volumes in the chambers of hydraulic jacks 26 and 36 by creating a movement, but simply by opposing it by creating a force opposing the tendency to swing.

The creation of this force resistant to the movement does not prevent the free oscillation of the axle.

No matter what the mode of operation, one seeks systematically to maintain the differences of the courses L26 and L36 of the hydraulic jacks 26 and 36 within a given range, so as to preserve the inclination of the axle relative to the machine within a given range.

The conditions of blocking a jack depend above all on the dynamic of return of the jack on one of the other of the sides of the machine. Then, it is the lateral inclination of the machine which permits taking this decision:
whether the jack returns (its course decreases) and that the machine inclines on the same side, the jack will be blocked.
whether the jack returns (its course decreases) and that the machine does not incline, whereupon the oscillation system is left free.
if the jack returns (its course decreases) and the machine inclines on the other side, the oscillation system is left free.

To this end, the standards for the controlled pressure limiters EV6+EV7 will be modified to prevent one jack from extending and the other retreating.

During this control, the relationship EV6+EV7=a constant will be respected, which constant itself depends on the load on the rear axle.

No interaction of interrupting the suspension is necessary (EV5=0) before any action on the controlled pressure limiters. The opposition to swinging is possible by free oscillation with or without an active suspension.

According to a modified embodiment (not shown) of the invention, the hydraulic circuit of the device according to the invention comprises in addition two pressure limiters in the hydraulic line on the piston rod side of the hydraulic jacks 26 and 36.

In case of the detection of swinging, the standard on the pressure limiter will be increased in the hydraulic line on the side of the base of the jack and decreased when the pressure limiter on the hydraulic line on the side of the rod of the other jack.

1. Control device, for a truck comprising an oscillating axle, comprising means to determine at least one physical parameter of the truck, and at least one dynamic parameter of the truck, by means actively to improve the lateral stability of the truck.

2. Device according to claim 1, characterized by the fact that the means actively to improve the lateral stability of the trick comprise means to apply a stabilizing couple (S) to the oscillating axle actively opposing the disequilibrium couple (D) of the truck.

3. Device according to claim 1, characterized by the fact that the device comprises at least one detector selected from the assembly of detectors of physical values of the truck, particularly: the angle of inclination of the beam, the load, the degree of telescoping, the angles of inclination of the truck.

4. Device according to claim 1, characterized by the fact that the device comprises at least one detector selected from the assembly of detectors of dynamic values of the truck, namely: angles of turning of the wheel, speeds of turning of the wheels, speed of advance of the truck, lateral acceleration of the truck.

5. Device according to claim 1, characterized by the fact that the device comprises at least one double acting jack (6, 26, 36) acting on the oscillating axle of the truck to actively improve the lateral stability of the truck.

6. Device according to claim 1, characterized by the fact that the device comprises processing means, for computing and control acting on the actuators (6, 26, 36) or members of the truck, particularly on a double acting jack (6, 26, 36) so as actively to improve the lateral stability of the truck.

7. Device according to claim 6, characterized by the fact that at least one jack (6) acting on the oscillating axle of the truck is controlled by a module (11) comprising a block (12) for regulation of pressure and a block (13) of several distributors (14, 15, 16a, 16b) having the function of blocking the jack (6), the free oscillation of the jack (6) and the pressurization of a first chamber (6a) of the jack (6) and the pressurization of a second chamber (6b) of the jack (6).

8. Device according to claim 6, characterized by the fact that at least one jack (6) acting on the oscillating axle of the truck is controlled by a module (21) comprising a block (2) for regulation of first pressure of first chamber (6a) of jack (6) and a block (23) for regulation of second pressure of second chamber (6b) of jack (6).

9. Device according to claim 1, characterized by the fact that the device comprises two jacks (26, 36) acting on the oscillating axle of the truck, to permit addition of supplemental functions.

10. Truck with oscillating axle comprising a device according to claim 1.
